(19) United States
(12) Patent Application Publication
(10) Pub. No.: US 2013/0041789 A1
(43) Pub. Date: Feb. 14, 2013

(54) PRODUCTION COST ANALYSIS SYSTEM

(71) Applicant: Christian Klensch, Angelbachtal (DE)

(72) Inventor: Christian Klensch, Angelbachtal (DE)

(73) Assignee: SAP AG, Walldorf (DE)

(21) Appl. No.: 13/207,013

(22) Filed: Aug. 10, 2011

(51) Int. Cl. G06Q 10/00

(52) U.S. Cl. 705/30

(57) ABSTRACT

A production cost analysis system may include data about goods and services stored in an in-memory database. The data may include information about routing, operation, work center, cost center, component, and activity. Production cost analysis may be performed on the data by aggregating the data in real-time, and may include calculating variances pertaining to target costs and actual costs associated with the stored data. The stored data may be viewed, edited, input, or analyzed through a user interface. Methods and devices are provided.

### BACKGROUND

Business software solutions for product cost controlling serve the purpose of providing a monetary valuation for processes residing in the logistics production area. Production entities like materials and production orders of finished products are assigned a monetary value along configured strategies and form a basis for complex calculations aimed at giving vital information on a production process' quality from a financial perspective.

Typically actual costs of production are compared with expected values from planning processes which are performed at defined discreet points in time. On a common calculation basis variances are calculated along defined characteristics which can be related to actual objects such as products, plants or production orders. An example of production cost analysis is this task of analyzing production processes along financial criteria.

While existing production cost analysis systems may be capable of aggregating and analyzing data on objects such as products, plants, or production orders, these capabilities may be limited. Organizations need to perform production cost analysis on a more granular level (i.e., on a level which provides more detailed information about the product or service being analyzed) in order to accurately allocate costs to production. However, existing production cost analysis systems cannot aggregate and analyze data on a more granular level due to the large amount of data and the necessity to access this data in real-time.

Accordingly, there is a need for a production cost analysis system which is capable of aggregating and analyzing data in real-time on more granular objects such as routing, operation, work center, cost center, component, and activity.

### BRIEF DESCRIPTION OF THE DRAWINGS

FIG. 1 shows exemplary entities in a production process according to an embodiment of the present invention.

FIG. 2 shows an exemplary interface for performing production cost analysis on a product and plant level.

FIG. 3 shows exemplary entities in a production process and illustrates categories of data which are stored and analyzed in an embodiment.

FIG. 4 shows an exemplary interface for performing production cost analysis on a cost center level in an embodiment.

FIG. 5 shows an embodiment of systems coupled to each other through a network.

### DETAILED DESCRIPTION

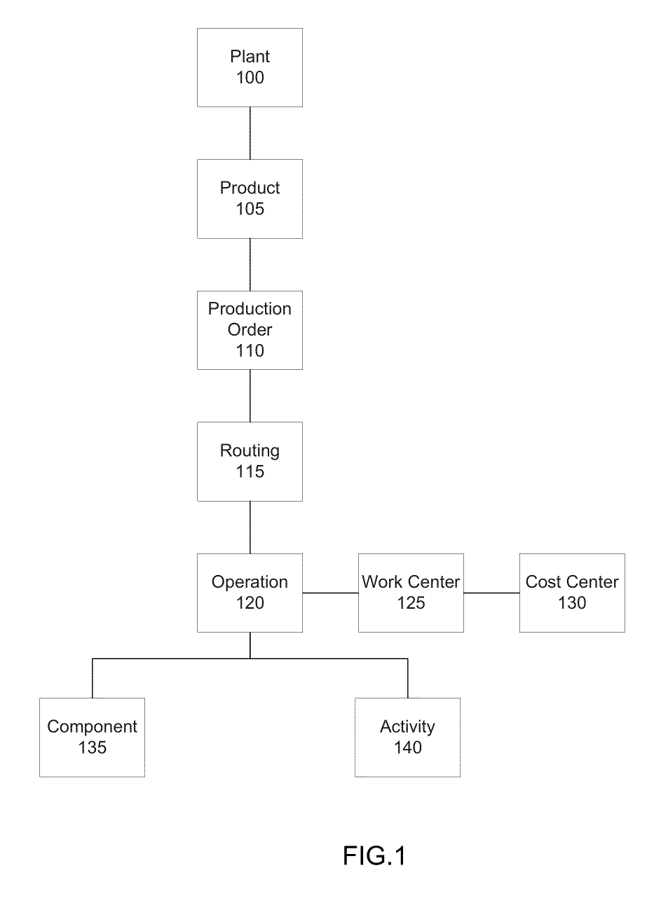

FIG. 1 illustrates a simplified production process. At the top level is the plant 100 which denotes a place where materials are produced, or goods and services are provided. An example of such a plant may be an automobile manufacturing facility. At the next level is the product 105, which denotes a good, material, or service that is bought, produced, and sold. A product can be either tangible, such as a physical good, or intangible, such as a service. An example of a product may be an automobile. At the next level is the production order 110, which denotes the manufacturing order used for discrete manufacturing. At the next level is routing 115, which denotes a description of the process used to manufacture plant materials or provide services in the manufacturing industry. At the next level is the operation 120, which denotes an activity (or activities) 140 performed using one or more components 135. An example of an operation may be attaching wheels on an automobile chassis, where the wheels and chassis are components 135 and the task of attaching the wheels is the activity 140. A work center 125 is an organizational unit that represents a suitably-equipped physical location where assigned operations 120 can be performed. A cost center 130 is an organizational unit where costs are incurred, and is linked to a work center 125.

In the past, production cost analysis (“traditional production cost analysis”) was performed by storing data from the plant 100, product 105, and production order 110, aggregating this data by running summarization processes at the end of defined intervals such as a week or a month, and then finally analyzing the aggregated data. As part of the analysis, variance calculation may be performed on the aggregated data to assess the efficiency and accuracy on a plant 100, product 105, and production order 110 level.

The data had to be aggregated at defined time intervals due to 1) the large amount of data generated on a plant 100, product 105, and production order 110 level even for a medium sized company, and 2) the lack of technology to access such large amounts of data in real-time. Due to the large amounts of data involved and the necessity for aggregating the data at defined time intervals, it was not practical to store or access data at a more detailed and granular level. Specifically, it was not practical to store or access data pertaining to routing 115, operation 120, work center 125, cost center 130, component 135, and activity 140, since the amount of data at these levels was a multiple of the data generated on a plant 100, product 105, and production order 110 level.

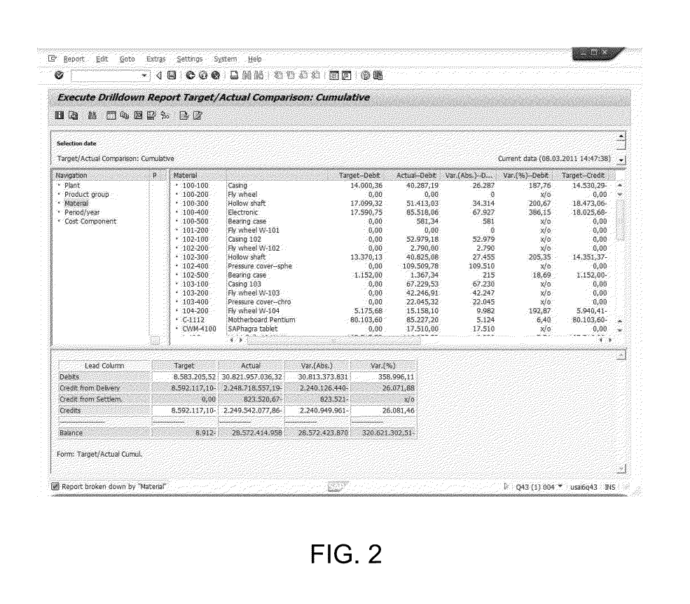

FIG. 2 shows an exemplary interface for performing traditional production cost analysis on a product and plant level. The interface does not display information pertaining to routing 115, operation 120, work center 125, cost center 130, component 135, or activity 140.

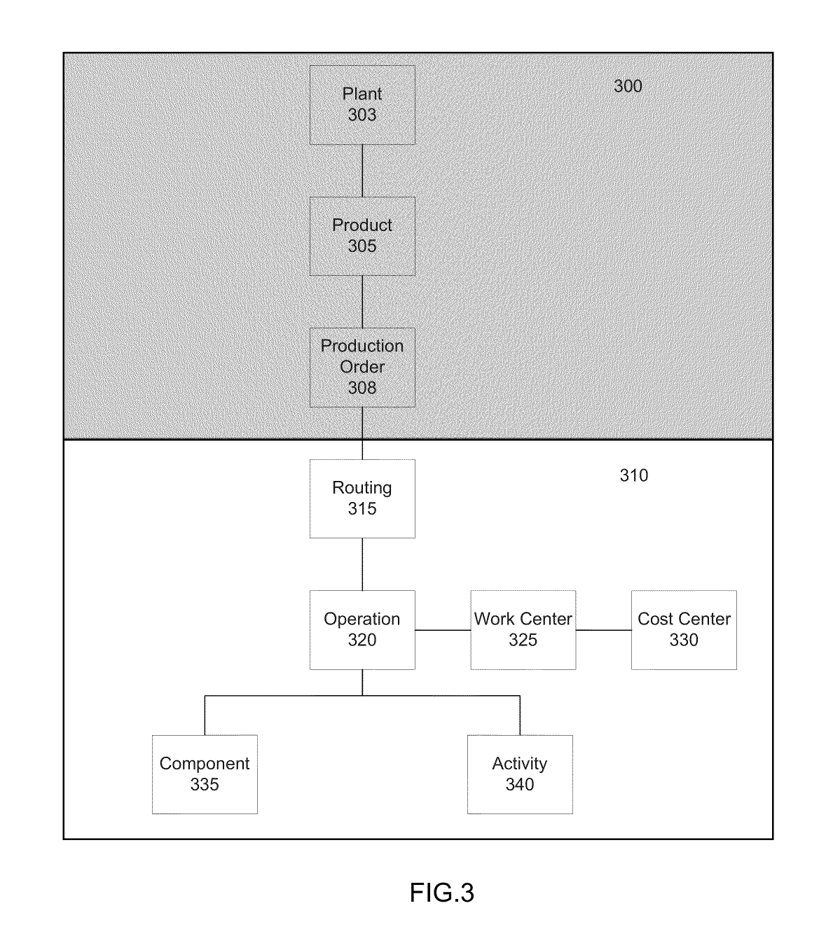

As explained above, traditional production cost analysis only analyzes data pertaining to the top half 300 of FIG. 3. Specifically, data pertaining to plant 303, product 305, and production order 308. Traditional production cost analysis produces information on whether plants work efficiently and reliably and which products cause (financial) problems during their production process, for example by pointing out costs which are much higher than expected/planned. However, traditional production cost analysis does not lead to solutions as it only allows a drill-down to production order level while the causes to the real problems are embedded below in the production structures. For example, traditional production cost analysis does not identify causes such as wrongly or incompletely estimated activity rates, inefficiently adjusted work centers, and wastefully allocated input material.

The limitations of traditional production cost analysis is due to traditional systems available for data storage. In traditional data storage systems, production data is usually split into two databases for performance reasons. Disk-based, row-oriented database systems are used for operational data and column-oriented databases are used for analytics (e.g. “sum of all sales in a company grouped by product”). While analytical databases are often kept in-memory, they can also be mixed with disk-based storage media.

Transactional data and analytical data are usually not stored in the same database:

analytical data is replicated in batch jobs and is stored in separate data warehouses. As a result, real-time reporting was not possible. However, in the last decade, hardware architectures have progressed dramatically. Multi-core architectures and the availability of large amounts of main memory at low costs have made it possible to store data sets of multiple companies in main memory. With in-memory database technology and hybrid databases using both row and column-oriented storage where appropriate, according to an embodiment of the present invention, transactional and analytical processing can be unified, resulting in performance that is orders of magnitude faster than traditional data storage systems.

With the advent of in-memory database technology, large amounts of data can be accessed and aggregated in real-time, therefore eliminating the need to aggregate data at defined time intervals. This in turn opens up new and improved ways to store, access, and analyze data. In-memory database technology includes systems such as SAP's HANA (high performance analytic appliance) in-memory computing engine.

In an embodiment, data pertaining to the lower half 310 of the production process in FIG. 3 is stored and analyzed. Specifically, data pertaining to routing 315, operation 320, work center 325, cost center 330, component 335, and activity 340 is stored and analyzed. In another embodiment, the analysis of the data includes production cost analysis. One of the advantages of analyzing the data at such a granular level is the ability to identify root causes of inefficiencies in the production process.

Analyzing data at a more granular level and performing real-time analysis on them opens up a new area of analytical possibilities at the interface between production and financials. The real-time capability, along with the possibility of identifying the responsible entities for inefficiencies (from a financial perspective) will help companies to react extremely quickly and adapt production processes until the expected efficiency is reached.

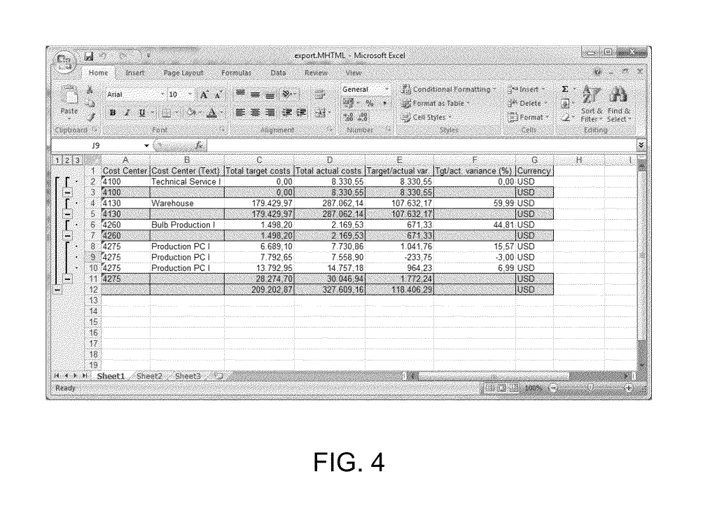

FIG. 4 shows an exemplary interface for analyzing data on a cost center level in an embodiment. As seen in FIG. 4, the target and actual costs associated with different cost centers are displayed. The variance associated with actual costs and target costs may also be calculated and displayed. In another embodiment, the interface may be used to edit the data, input additional data, or further analyze the data.

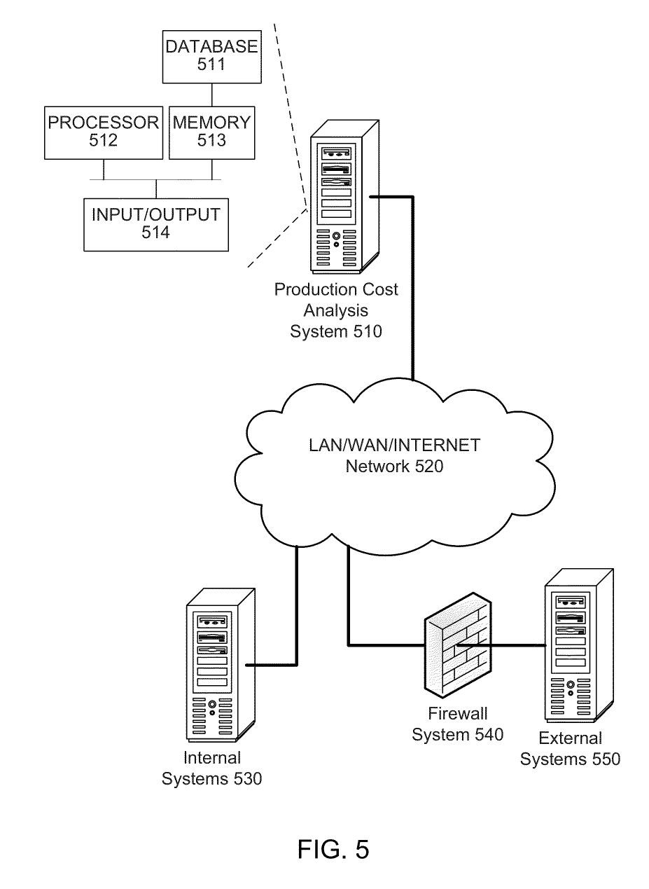

FIG. 5 shows an embodiment of a production cost analysis system 510 coupled to existing internal systems 530 through a network 520 and to external systems 550 through the network 520 and firewall system 540. The existing internal systems 530 may include one or more of pricing, inventory management, variance calculation, and other systems of an organization. The external systems 550 may be maintained by a third party, such as a newspaper, information service provider, or exchange, and may contain pricing information for various goods, services, currencies, or intangible assets, that may be updated by the third party on a periodic basis. The production cost analysis system 510 may interact with these external systems to obtain pricing and delivery updates through a firewall system 540 separating the internal systems of the organization from the external systems.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may contain different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems. The database 511 may include SAP's HANA (high performance analytic appliance) in-memory computing engine and other such in-memory databases.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
storing, through a processing device, data in an in-memory database;
analyzing, through a processing device, the stored data in the in-memory database, wherein the stored data includes information relating to least one of operation, work center, cost center, component, and activity.

2. The method of claim 1, wherein analyzing the data includes aggregating the data in real-time.

3. The method of claim 1, wherein analyzing the data includes production cost analysis.

4. The method of claim 1, wherein the stored data can be at least one of viewed, edited, input, or analyzed through a user interface.

5. The method of claim 3, wherein the production cost analysis includes assigning production costs in real-time to at least one of operation, work center, cost center, component, and activity.

6. The method of claim 3, wherein the production cost analysis includes calculating variances pertaining to target costs and actual costs associated with at least one of operation, work center, cost center, component, and activity.

7. A device comprising a non-transitory computer-readable storage medium including instructions, that when executed by a processor, cause the processor to:
store data in an in-memory database;
analyze the stored data in the in-memory database, wherein the stored data includes information relating to least one of operation, work center, cost center, component, and activity.

8. The device of claim 7, wherein analyzing the data includes production cost analysis.

9. The device of claim 7, wherein analyzing the data includes aggregating the data in real-time.

10. The device of claim 7, wherein the stored data can be at least one of viewed, edited, input, or analyzed through a user interface.

11. The device of claim 8, wherein the production cost analysis includes assigning production costs in real-time to at least one of operation, work center, cost center, component, and activity.

12. The device of claim 8, wherein the production cost analysis includes calculating variances pertaining to target costs and actual costs associated with at least one of operation, work center, cost center, component, and activity.

13. A system for analyzing data comprising:
a processing device configured to:
store data in an in-memory database;
analyze the stored data in the an in-memory database, wherein the stored data includes information relating to least one of operation, work center, cost center, component, and activity.

14. The system of claim 13, wherein analyzing the data includes aggregating the data in real-time.

15. The system of claim 13, wherein analyzing the data includes production cost analysis.

16. The system of claim 13, wherein the stored data can be at least one of viewed, edited, input, or analyzed through a user interface.

17. The system of claim 15, wherein the production cost analysis includes assigning production costs in real-time to at least one of operation, work center, cost center, component, and activity.

18. The system of claim 15, wherein the production cost analysis includes calculating variances pertaining to target costs and actual costs associated with at least one of operation, work center, cost center, component, and activity.
